(19) United States
(12) Patent Application Publication
(10) Pub. No.: US 2022/0207000 A1
(43) Pub. Date: Jun. 30, 2022

(54) Method to create data of correspondence between an object and object information

(71) Applicant: Alexey Fedorovich Khoroshev, Moscow (RU)

(72) Inventor: Alexey Fedorovich Khoroshev, Moscow (RU)

(21) Appl. No.: 17/438,073

(22) PCT Filed: Mar. 10, 2020
(86) PCT No.: PCT/RU2020/000124

§ 371 Date: Sep. 10, 2021

(30) Foreign Application Priority Data
Mar. 12, 2019 (RU) 2019106947

(51) Int. Cl. G06F 16/21

(52) U.S. Cl. CPC G06F 16/21

(57) ABSTRACT

A method to create data of correspondence between an object and object information, consisting in recording, simultaneously and in conjunction with the object, the effect of the signal forming the data of correspondence between the object and object information on such object. The deliverable is more convenient information transfer, interpretation or processing by humans or computers, a broader range of tools for data generation and various applications, a fundamentally new method for a new purpose, namely implementation of a method to create data of correspondence between an object and object information.

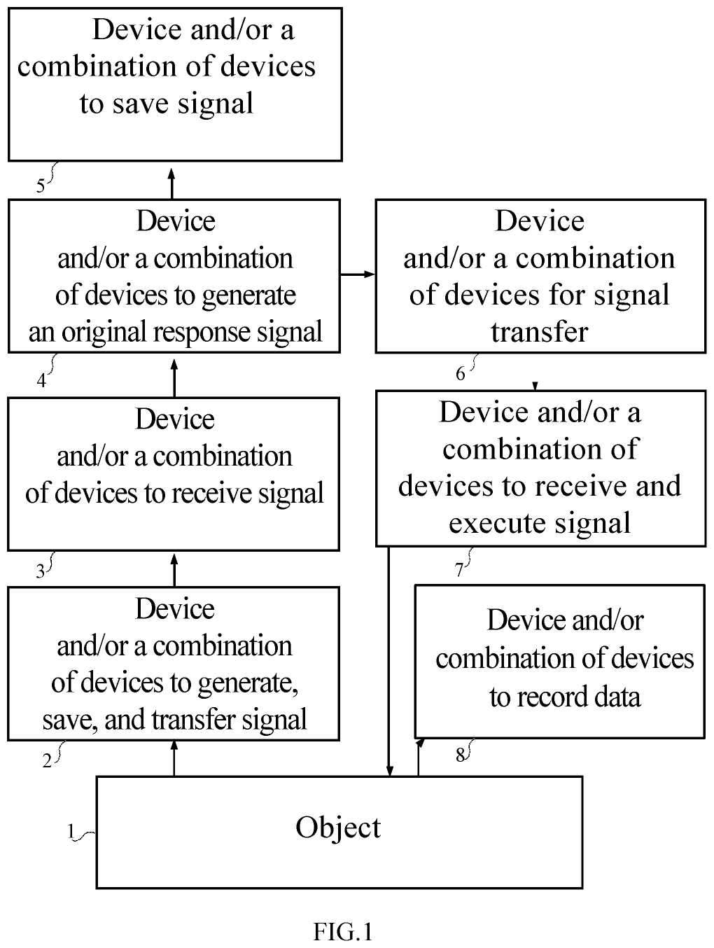

### FIELD OF INVENTION

The primary field of application of the invention, “Method to create data of correspondence between an object and object information”, hereinafter also referred to as Invention, is information generation, processing, use, and transfer.

### PRIOR ART

Various methods to create, process, use, and transfer information as data are widely known (data: provision of information in formal format which allows transfer, interpretation, or processing by humans or computers. (Russian Government Standard GOST 33707-2016 (ISO/IEC 2382:2015). Information technologies (IT). Dictionary)). The reliability of data as information about an object, i. e., about a thing, action, event, phenomenon, and such like existing outside a subject's mind, consists in an exhaustive uniqueness of the relationship between the object and object information, which is established in available aspects only by analyzing object information while the correspondence itself between the object and object information in data form, that is in formal format which allows transfer, interpretation, or processing by humans or computers, is not created. One potential means to improve the convenience of information transfer, interpretation, or processing by humans or computers could be to create data of correspondence between the object and object information; however, tools designed to do the job are not available now, whereas the Invention solves the problem of creating such tools. Thus, the Invention has no analogous art.

### SUBSTANCE OF INVENTION DISCLOSED

The essence of the Invention as a technical solution manifests itself in the below totality of substantial features, sufficient to attain the technical outcome ensured by the Invention:

A method to create data of correspondence between an object and object information, consisting in recording, simultaneously and in conjunction with the object, the effect of the signal forming the data of correspondence between the object and object information on such object.

The above Invention generates the below technical deliverables:

more convenient information transfer, interpretation or processing by humans or computers, a broader range of tools for data generation and various applications, a fundamentally new tool for a new purpose, namely implementation of a method to create data of correspondence between an object and object information.

### BRIEF DESCRIPTION OF DRAWINGS

More purposes, features and advantages of this Invention will become evident after reading the following description of Invention implementation with reference to a drawing exemplifying the substance of the Invention, which—

by way of an example, shows a simplistic option, in line with the Invention, of implementing a method to create data of correspondence between an object 1 and object information, which are recoded by means of a data recording tool and/or a combination of tools 8.

Although the Invention can have various modifications and alternative forms, the characteristic features shown by the drawings as an example will be described in detail. It should be borne in mind, however, that the purpose of the description is not to confine the Invention with any specific implementation. On the contrary, the description aims to cover all alterations and modifications within the framework of the Invention in question, as defined by the claim of the Invention.

### IMPLEMENTATION OF INVENTION

The Invention will be described in detail below. It should be noted that the Invention is not limited to the below-specified implementation options. Besides, the components of the Invention implementation options described below include elements which can be easily visualized by a regular professional in the respective field of art or elements which basically are the same as elements that can be easily visualized by a rank-and-file professional in the respective art.

For instance, the Invention can be implemented as the below use of a set of tools including at least, but not limited to, a device (like a mobile phone, a smartphone, a tablet computer, a notebook, etc., not limited to that, and/or a combination thereof) and/or a combination of devices 2 designed to generate, save, and transfer signals (such as electric, electromagnetic, optical, acoustic, or other signals not limited to those, and so on, and/or a combination thereof) generating, saving, and transferring a signal indicating the start of object 1 recording by means of any respective type of communication (such as radio, telephone, acoustic, or other not limited to those specified above, and/or a respective combination thereof) to a device (such as a mobile phone, a smartphone, a tablet computer, a notebook, a different computer, or anything else not limited to the above-said and so on, and/or a respective combination thereof) and/or a combination of devices 3 to receive such signal, which, in response to such signal, triggers a device (such as an image generator (like figures, numbers, pictures, or anything else, but not limited to the above, and/or a respective combination thereof), a pulse generator (such as electrical, electromagnetic, optical, acoustic, other, but not limited to the above, and/or a respective combination thereof), or other kinds, not limited to the above, and/or a respective combination thereof, designed with a unique characteristic in at least one parameter (such as the content, colour, shape, intensity, duration, sequence, interval pattern, or other, but not limited to the said, and/or a respective combination thereof)) and/or a combination of devices 4 to generate an original response signal (such as electrical, electromagnetic, optical, acoustic, other, but not limited to the said, and/or a respective combination thereof), saved by a device (such as a memory device saving it to a hard disk, magnetic tape, optical disk, flash drive, microchip, or other device, but not limited to the above, and/or a respective combination thereof) and/or a combination of devices 5 to save the signal, and transferred, at the same time, by a device (such as a mobile phone, smartphone, tablet computer, notebook, any other computer, anything else, but not limited to the above, and/or a respective combination thereof) and/or a combination of devices 6 for signal transfer by means of any respective communication (such as radio, telephone, acoustic communication, other kinds, but not limited to the above, and/or a respective combination thereof) to a device (such as a mobile phone, smartphone, tablet computer, notebook, any other computer, or anything else, but not limited to the above, and/or a respective combination thereof) and/or a combination of devices 7 to receive and execute such signal (such as electrical, electromagnetic, optical, acoustic, or other kinds, but not limited to the above, and/or a respective combination thereof) by respective effect (such as electrical, electromagnetic, optical, acoustic, or other, but not limited to the above, and/or a respective combination thereof) on the object, so that a respective unique characteristic, in terms of at least one respective parameter (such as content, color, shape, intensity, duration, sequence, interval pattern, or other, but not limited to the above, and/or a respective combination thereof), or anything else, but not limited to the above, and/or a respective combination thereof) in an indivisible combination with at least one unique characteristic of the object itself is present in that effect, enabling a device (such as a video camera, mobile phone, smartphone, tablet computer, notebook, anything else, but not limited to the above, and/or a respective combination thereof) and/or a combination of data recording devices 8 to record, as information in formal format suitable for transfer, interpretation or processing by humans or computers, such effect including the above indivisible combination, which objectifies the very correspondence between the object and object information, thus creating an object of above-said correspondence as provision of information in formal format suitable for transfer, interpretation or processing by humans or computers, i. e., as data, for instance, in a relationship of a party expressing volition and a volition recipient, the object is a party's verbal, sound volition in combination with typical gestures, for example moving the face, including that with open eyes, left and right for negation or up and down for agreement, where at the beginning a starting signal is transferred from the volition making party 1 via a telecommunication device 2 at his disposal to a telecommunication device 3, which is at the disposal of volition recipient, connected to a device 4 which generates random combinations of figures whose digit capacity is such that a coincidence is completely ruled out in a relevant comparison interval, for example 100 years, produces, in accordance with these combinations of figures, an authentic response signal to be performed as an authentic respective combination of light pulses in an authentic respective sequence, which is saved by a signal saving device 5 and at the same time is transferred via a telecommunication device 6 possessed by the volition recipient to a telecommunication device 7 possessed by the volition maker in such a way that the source of artificial light in that device, such as the screen of device 7 among other things, changes the illumination level of the volition maker's iris in the above-mentioned authentic sequence of authentic respective light pulse combinations during the time interval when the data of correspondence between volition and volition information are generated, causing, in the context of the original verbal communication of the person's volition content, responses in the form of constriction or dilation of the pupils, openings in the central area of the unique irides in eyes, involved in the authentic face movements, in the above authentic sequence of the original respective light pulse combinations, while their picture and sound recording as an effect on the object, the person's volition 1, in connection with the volition 1 itself, during the period of generating correspondence data between volition 1 and volition information, is made by data recording device 8, thus creating the above correspondence (between the object 8 and object information) as provision of information in formal format suitable for transfer, interpretation, or processing by humans or computers, that is, data of correspondence between the object and object information are created, which data can be, for example, transferred to the telecommunication device possessed by the volition making person and, simultaneously, to the telecommunication device of the volition recipient, making it possible to handle them in any way.

If necessary, the exposition of the above variant of implementing the presented Invention should be viewed as an exposition of at least the best of the applicant's suggested variants of implementation of the submitted Invention.

To conclude, it should also be noted that, while the Invention was described with reference to possible examples of its implementation, it must be borne in mind that the Invention is not limited to the possible implementation examples or above-described material or designs, but it covers all and any variants falling within the scope of the claim. It should also be understood that the Invention is designed to cover various modifications and equivalent placements and any other Invention uses as well. Also, one should realize that while the various elements of possible implementation variants have been described in various combinations and configurations, which serve as examples, other combinations and configurations including a bigger or smaller number of elements or just one element, too, can fall within the essence and scope of the Invention.

### COMMERCIAL APPLICABILITY

Obvious from the description and nature of the invention.

1. A method to create data of correspondence between an object and object information, consisting in recording, simultaneously and in conjunction with the object, the effect of the signal forming the data of correspondence between the object and object information on such object.
